(19) United States
(12) Patent Application Publication
(10) Pub. No.: US 2002/0104010 A1
(43) Pub. Date: Aug. 1, 2002

(54) Workstation with computers in the legs of the station

(76) Inventor: Richard Zodnik, San Juan Capistrano, CA (US)

Correspondence Address: IRELL & MANELLA LLP, 840 Newport Center Drive, Suite 400, Newport Beach, CA, 92660, US

(21) Appl. No.: 09/772,355

(22) Filed: Jan. 29, 2001

(51) Int. Cl. G06F 11/30

(52) U.S. Cl. 713/200

(57) ABSTRACT

A workstation that has one or more computers located in a leg(s) of the station. The workstation may have a plurality of monitors that extend from a table top. The table top is supported by the legs of the station. The monitors can be coupled to corresponding computers located within the table legs. Each computer may be plugged into a backplane mounted to the leg(s). The backplane can be coupled to one or more external networks. One of the legs may also contain a router that is coupled to the network(s) by a single cable. The router transmits information to and between the computers of the workstation. Having a single cable reduces the complexity and cost of installing the workstation in a building structure. Locating the computers within the legs reduces the profile and decreases the corresponding floor space required for the station.

### BACKGROUND OF THE INVENTION

1. Field of the Invention

The present invention relates to a computer workstation.

2. Background Information

The trading floor of a brokerage house typically has a large number of trading stations each occupied by a trader. Each trading station may have a plurality of cathode ray tube (CRT) monitors located on the top of a table. Each monitor is connected to a computer located under the table top. Each monitor may display different information such as stock charts, etc.

CRT monitors are typically bulky and occupy a lot of table space. Additionally, the computers occupy a lot of floor space. Commercial floor space can be a valuable asset for the entity leasing or owning the space. It would be desirable to provide a workstation that provides multiple screens, occupies a minimal amount of floor space, and provides an optional amount of table space.

Each computer is typically connected to a network by a cable. The cables must be routed through the building structure to hubs, routers and servers of the network. Routing a large number of cables is time consuming and increases both the time and cost associated with installing the computers. It would be desirable to provide a workstation that required a minimal amount of cables.

The computers at each trading station are typically linked to the network through data ports that are connected to a number of routing wires. Each data port has an associated physical address. Each computer has an associated network address. The hubs and routers of the network will route information directed to the network addresses of the computers to the appropriate physical addresses of the data ports.

Some computers also have modem boards that are connected to voice ports of a telephone network. Each voice port has a unique phone number to allow routing of incoming phone information transmitted through the phone network. The telephone network will typically have switches to route phone calls to the appropriate physical cable address of the voice port.

The server of the network may have a software program that allows an operator to correlate the network address of the computer with the physical address of the data port. This correlation allows the network router and hub to route information to the appropriate computer. Likewise, the switch(es) of the telephone network may have a software program that allows an operator to correlate a phone number with a particular voice port.

Brokerage houses will periodically move employees to different office locations. This typically requires moving the employee's computer. Each time a computer is installed to a different location an operator must re-configure the server and/or phone switches to correlate the computer with the new data and voice port locations. Re-configuring the network is time consuming and adds to the cost of moving the employees. It would be desirable to provide a system and method that allows an end user to plug a computer into a network and have the network automatically re-configured without any operator assistance.

### BRIEF SUMMARY OF THE INVENTION

One embodiment of the present invention is a workstation that includes a leg that supports a top. The workstation also includes a computer that is located within the leg.

### BRIEF DESCRIPTION OF THE DRAWINGS

FIG. 1 is a front perspective view of an embodiment of a workstation of the present invention;

FIG. 2 is a right rear perspective view of the workstation;

FIG. 3a is a right side perspective view of the workstation;

FIG. 3b is a back view showing a bracket of the workstation;

FIG. 4 is a cross-sectional view of a leg of the work station;

FIG. 5 is an illustration showing an embodiment of a computer and a backplane of the present invention;

FIG. 6 is a schematic of a system that includes the computer and backplane;

FIG. 7 is a schematic showing a plurality of computers coupled to a network by a router of the workstation;

FIG. 8 is a diagram showing a relational database stored by a server of the system;

FIG. 9 is a flowchart showing an operation of the system.

### DETAILED DESCRIPTION OF THE PREFERRED EMBODIMENT

In general the present invention includes a workstation that has one or more computers located in a leg(s) of the station. The workstation may have a plurality of monitors that extend from a table top. The table top is supported by the legs of the station. The monitors can be coupled to corresponding computers located within the table legs. Each computer may be plugged into a backplane mounted to the leg(s). The backplane can be coupled to one or more external networks. One of the legs may also contain a router that is coupled to the network(s) by a single cable. The router transmits information to and between the computers of the workstation. Having a single cable reduces the complexity and cost of installing the workstation in a building structure. Locating the computers within the legs reduces the profile and decreases the corresponding floor space required for the station.

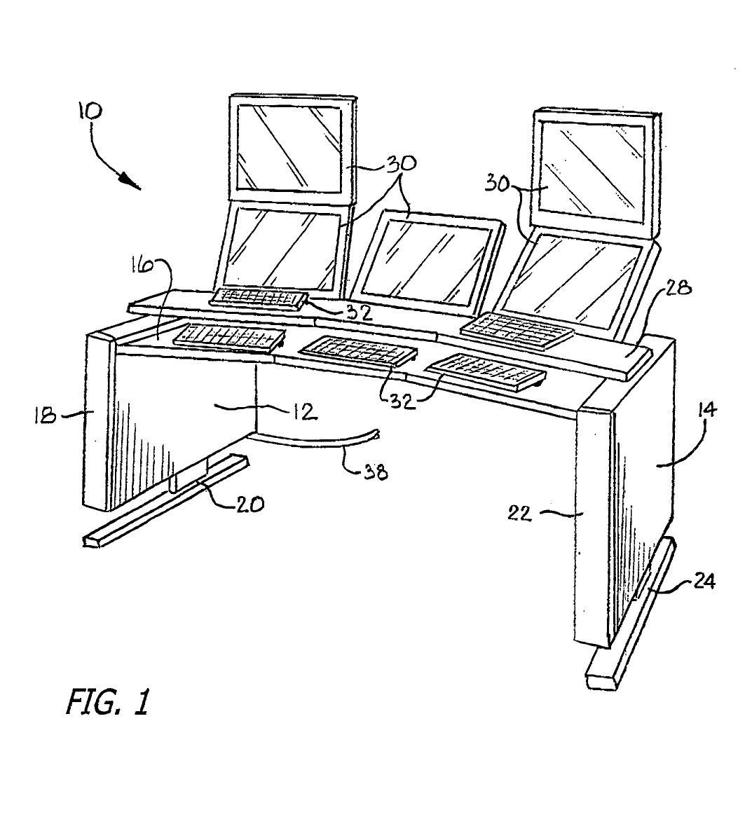

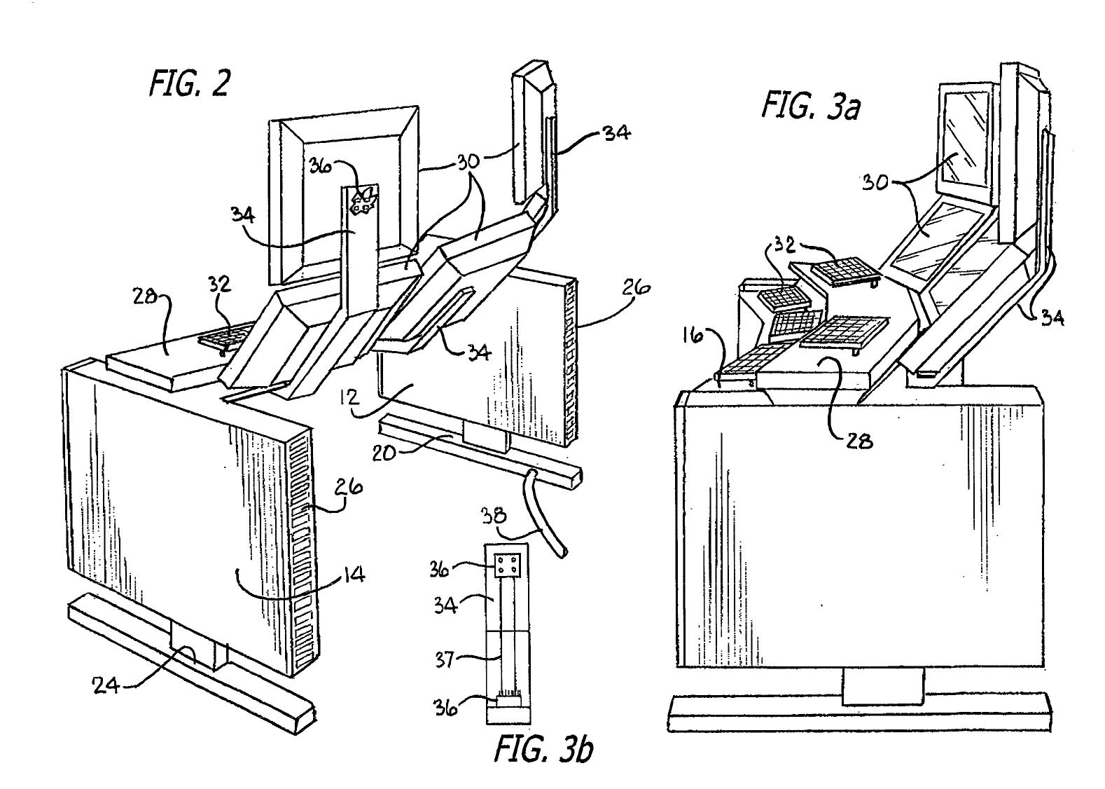

Referring to the drawings more particularly by reference numbers, FIGS. 1-3b show an embodiment of a workstation 10 of the present invention. The workstation 10 may include a first leg 12 and a second leg 14 that support a table top 16. The first leg 12 may include a first cabinet 18 that is attached to the table top 16 and supported by a foot 20. Likewise, the second leg 14 may include a second cabinet 22 that is attached to the table top 16 and supported by a foot 24. Each cabinet 18 and 22 has a plurality of apertures 26 that allow heat to be removed by forced convection. The cabinets 18 are also preferably constructed from a thermally conductive metal material to allow heat removal by conduction and natural convection.

The table top 16 may include an upper shelf 28 to create additional workspace for the end user. A plurality of monitors 30 may extend from the table top 16. The monitors 30 are preferably relatively thin devices that are commonly referred to as flat panel displays. A plurality of keyboards 32 may be located on the table top 16 and shelf 28. The keyboards 32 may transmit wireless signals to reduce the wiring associated with the station 10. The wireless signals may be infrared (IR), radio frequency (RF) or any other type of signal transmission.

Corresponding brackets 34 can couple the monitors 30 to the table top 16. Each bracket 34 may have one or more electrical connectors 36 that mate with corresponding connectors of the monitors 30 and a mating connector (not shown) in the table top 16. As shown in FIG. 3b, the connectors 36 may be coupled together by corresponding wires 37. The wires 37 may be integrated into a flexible circuit, harness or other structure that can be readily attached to the bracket 34. The bracket 34 may also have quick connect fasteners (not shown) that can be readily connected to the table top 16 and the monitors 30. The bracket 34 provides a modular component that decreases the time required to assemble the workstation 10. The monitors 30 can be installed by merely pressing the bracket 34 into the table top 16 and then snapping a monitor 30 into the bracket 34. This can be advantageous when installing a number of workstations 10 at a commercial facility.

Cables or flex circuits (not shown) may extend along the inner surface of the brackets 34 and undersurface of the table top 16 to the cabinets 18 and 22. In this manner the wiring for the monitors 30 is hidden from view. Additionally, the bracket connectors 36 allow the monitors 30 to be readily assembled to the workstation 10 during installation. The station 10 may also have hidden wiring between the legs 12 and 14 that extend along the undersurface of the table top 16. The workstation 10 may have a single cable 38 that provides power and data/phone connections to external networks, power etc.

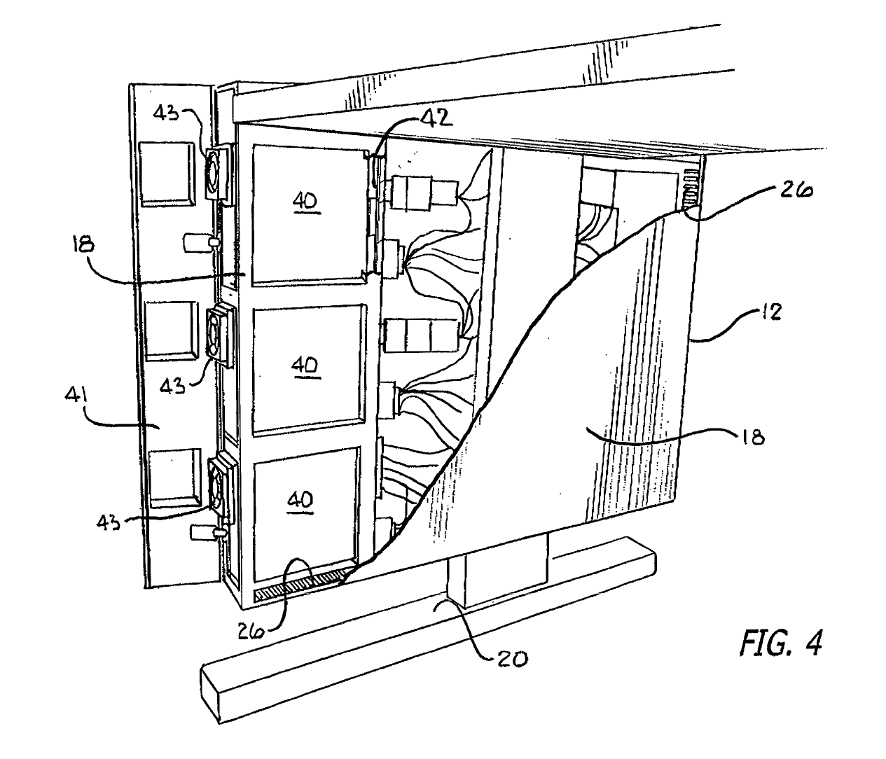

FIG. 4 shows a plurality of computers 40 that are located within the legs 12 and 14. The computers 40 are accessible through a door 41 of the cabinet 18. Each computer 40 can be plugged into a backplane 42 mounted to the cabinets 18 and 22. Each computer 40 may have an integral fan 43 that creates air flow and removes heat.

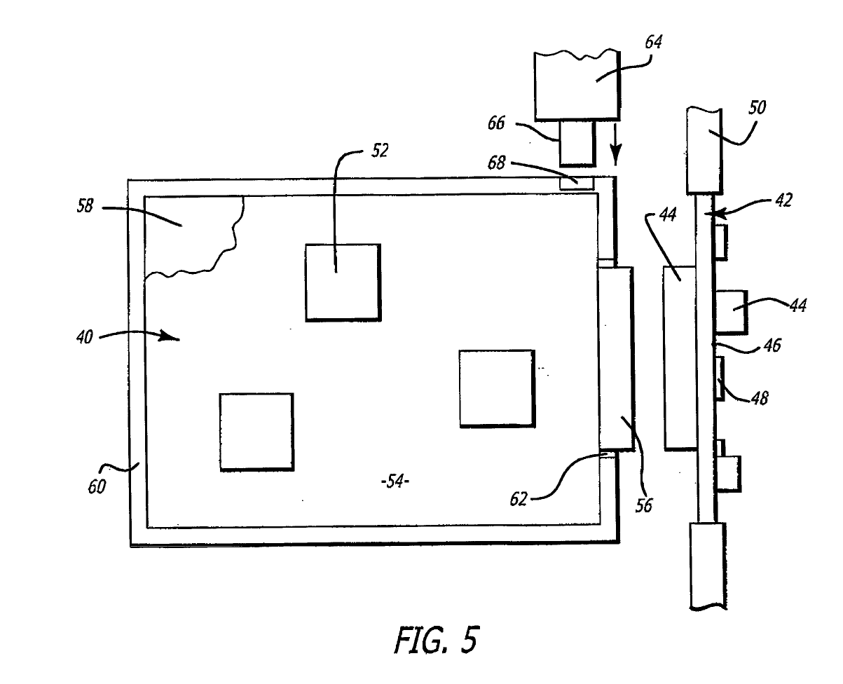

FIG. 5 shows a computer 40 and a backplane 42 of a system of the present invention. The backplane 42 may include a plurality of electrical connectors 44 mounted to a printed circuit board 46. Each electrical connector 44 may have a keying feature to insure that only the proper corresponding device can be mated with a corresponding connector 44. The printed circuit board 46 may support a plurality of integrated circuits 48 that are connected to the connectors 44. The backplane 42 may be mounted to a wall 50 of a cabinet 18 or 22.

The computer 40 may include a plurality of integrated circuits 52 mounted to a printed circuit board 52 The integrated circuits 52 may be connected to an electrical connector 56 that is attached to the board 54. The connector 56 may mate with one of the connectors 44 of the backplane 42. The printed circuit board 54 may also be connected to a hard disk drive 58. The hard disk drive 58 is coupled to the integrated circuits 52. The printed circuit board 54, integrated circuits 52 and hard disk drive 58 may all be enclosed by an outer housing 60. The outer housing 60 will have an opening 62 to allow the connectors 56 and 44 to mate.

The workstation 10 may include a mechanical lock 64 that is mounted to the structure 50. The lock 64 can be actuated to secure the computer 40 to the backplane 42. By way of example, the lock 64 may be a solenoid actuated plunger 66 that moves into a corresponding slot 68 the housing 60. The plunger 66 can be moved out of the slot 68 to allow the computer 40 to be pulled out of the backplane 42.

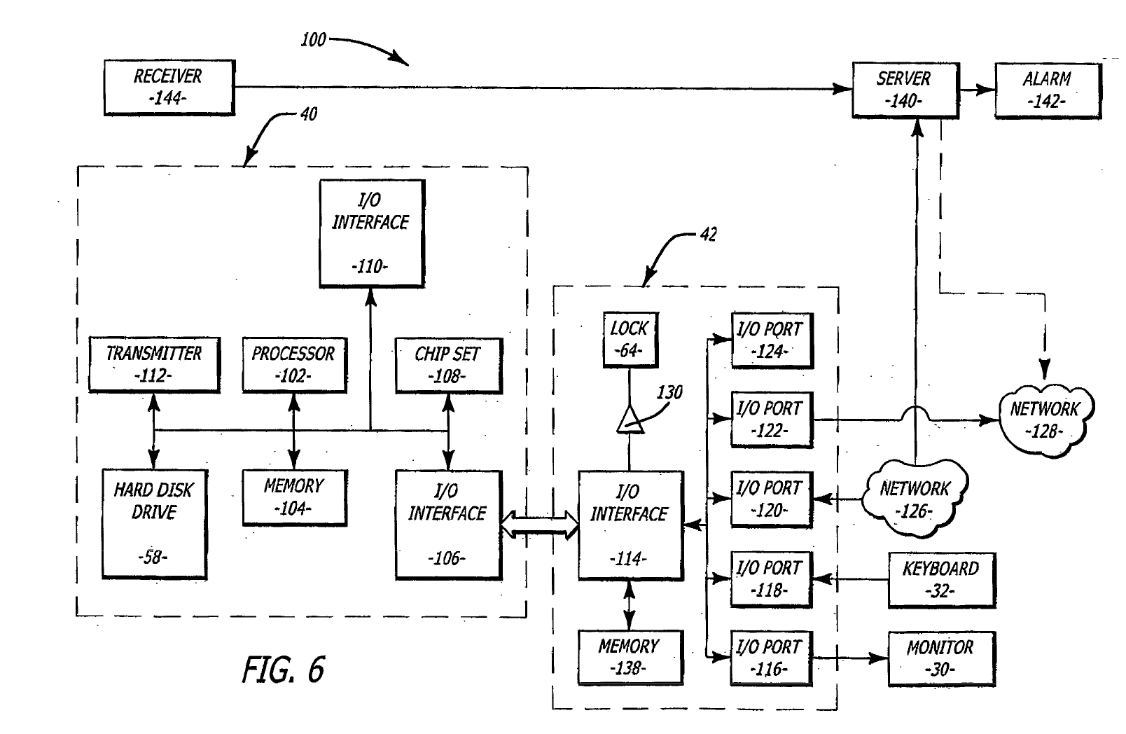

FIG. 6 shows a schematic of a system 100 with a single computer 40 and a single backplane 42. Although one computer 40 and backplane 42 are shown and described, it is to be understood that there may be a backplane 42 within each leg 12 and 14 of the workstation 10. For example, the system 100 may include three computers plugged into the backplane 42 of one leg 12 or 14 and two computers 40 plugged into the backplane 42 of another leg 12 or 14. The computers 40 can each be coupled to a corresponding monitor 30 and keyboard 32. Although five computers, monitors and keyboards are shown and described, it is to be understood that the workstation may have a different number of computers, etc.

Each computer 40 may include a microprocessor 102 that is coupled to one or more memory devices 104, an input/output (I/O) interface 106 and the hard disk drive 58. The memory devices 104 may include volatile and/or non-volatile memory such as dynamic read only memory (DRAM), static random access memory (SRAM) and read only memory (ROM).

The I/O interface 106 is connected to the connector 56 shown in FIG. 5. The microprocessor 102 may also be connected to a graphics controller that is integrated with other functions such as bus management in an integrated circuit commonly referred to as a chip set 108. The microprocessor 102 may also be connected to a secondary I/O interface 110. The secondary I/O interface 110 can be coupled to an external device such as additional memory (not shown).

Each computer 40 may also have a transmitter 112 that can wirelessly transmit signals. The wireless transmission may be at radio frequency (RF). The transmitter 112 may be coupled to a non-volatile memory device that contains an RF id. If the computer 40 is not properly shut down and detached from the backplane 42, the transmitter 112 may then automatically transmit the RF id on a continuous or periodic basis. For example, the computer 40 may require a password or biometric entry to properly shut down and remove the computer 40. If the passwork/biometric is not properly entered and the operator pulls the computer 40 out of the backplane 42, the processor 102 may cause the transmitter 112 to emit the RF id. The computer 40 would have a battery (not shown) to provide power to the transmitter 112.

Each backplane 42 may have an I/O interface 114 that is connected to I/O ports 116, 118, 120, 122 and 124. Each I/O port 116, 118, 120, 122 and 124 is connected to a corresponding connector 44 shown in FIG. 5. The I/O interface 114 is also connected to a connector 44 that can be mated to the computer 40.

The I/O ports 116, 118, 120, 122 and 124 can be connected to external devices that communicate with the backplane 42 using different signals and different protocols. The interface 114 may contain the protocols required to transmit information through the ports 116, 118, 120, 122 and 124. The ports 116, 118, 120, 122 and 124 may have circuits to drive the signals to interface with the physical layer of the external device.

By way of example, I/O port 116, may be connected to a monitor 30. The I/O interface 114 and I/O port 116 can be configured to transmit signals from the computer 40 in accordance with signal levels, protocols required to drive the monitor 30. The I/O interface 114 may include a hot plug firmware routine that determines the protocol, signals required to drive the monitor 30 through a series of handshake signals transmitted between the devices 114 and 30.

I/O port 118 may be connected to a keyboard 32. The interface 114 and ports 118 may be configured to provide protocols and signal levels which allow information to be transmitted to the computer 40 from the keyboard.

I/O port 120 may be connected to a network 126. The network 126 may be a local area network (LAN), metropolitan area network (MAN) or a wide area network (WAN), or combination of LAN, MAN and/or WAN. By way of example, the I/O port 120 may include integrated circuits that transmit signals in accordance with the Ethernet standard. Information may be transmitted through the network 126 in accordance with a Transmission Control Protocol/Internet Protocol (TCP/IP).

I/O port 122 may be connected to a telephone network 128. The telephone network 128 may be a plain old telephone system (POTS), a public telephone network (PTN), Integrated Service Data Network (ISDN), Digital Subscriber Line (DSL) or another other phone service. The interface 114 and port 122 may transmit information in accordance with the signal levels and protocol of the telephone network.

A backplane 42 that is coupled to a plurality of computers 40 may have a plurality of I/O interfaces 114 and parts 116, 118, 120, 122 and 124 that each correspond to a computer 40. For example, if the backplane 42 can be coupled to three computers 40 the backplane 42 will have three I/O interfaces 114, three I/O ports 116, etc.

I/O port 124 may be an open port for additional devices. For example, port 124 may support USB protocol. The backplanes 42 may each have additional ports that support other past, present and future protocols and physical layer specifications. The I/O interface 114 may also be connected to the lock 64 by lock driver 130.

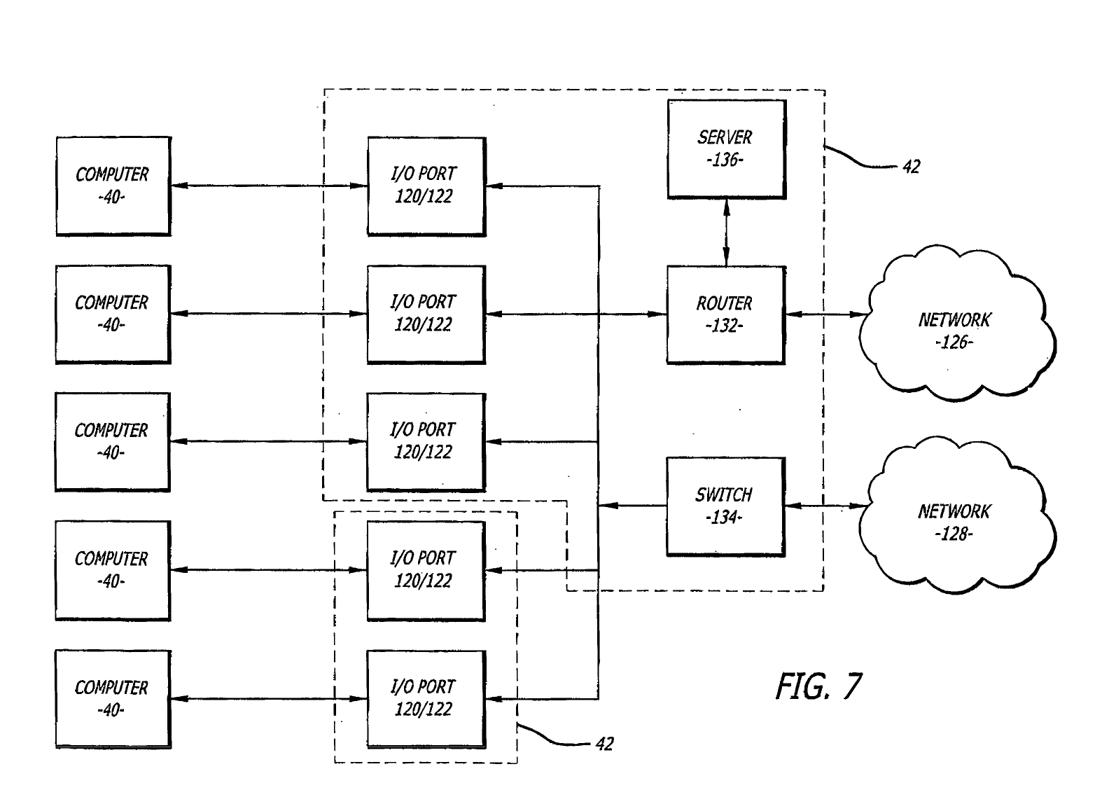

FIG. 7 is a schematic showing a plurality of computers 40 coupled to the network. One of the backplanes 42 may have a router 132 that is connected to the network 126 and may be coupled to the computers 40. The router 132 can route information from the network 126 to one of the computers 40 in accordance with a network address. By providing a router 132 on a backplane 42 located within a leg 12 or 14, the number of cables required to connect the workstation 10 to the network 126 can be reduced to one. Additionally, the backplane 42 may include a switch 134 that is coupled to the telephone network 128. The switch 134 can properly route incoming information from the phone network 128 to the appropriate computer 42. The existence of a switch 134 reduces the number of phone lines required to connect the station 10 to the phone network 128. The switch 134 may be integrated with the router 132. The backplane 42 may further have a server 136 that is coupled to the router 132. The server can store databases, etc. used by the computers 42 and accessed through the network 126.

Referring to FIG. 6, the backplane 42 may have a memory device 138 that is connected to the I/O interface 114. The memory device 138 may be non-volatile memory such as an EEPROM. The memory device 138 may include a backplane identification. The backplane identification is unique to the backplane 42.

By way of example, there are typically a plurality of workstations 10 and backplanes 42 connected to the networks 126 and 128. Each backplane 42 will have a different backplane identification. The backplane identification may be a series of alphanumeric characters. The backplane identification may also be encrypted.

The computer 40 may also store a unique client identification. The client identification may include personal information of the computer end user. The personal information may include a network address and telephone number for the computer. The client identification may be encrypted or otherwise encoded. The client identification may also be stored in at least one hidden sector of the hard disk drive, to prevent unauthorized access of the client ID.

The system 100 may include a server 140 that is connected to the network 126. The server 140 may also be connected to the telephone network 128, an alarm 142 and a receiver 144. The receiver 144 can be adapted to receive the signal emitted by the transmitter 112 of the computer 40. The alarm 142 may include an audio and/or visual indicator such as a speaker and LCD display, respectively.

The network 126 may include routers and hubs (not shown) that route information to the computers 40 in accordance with a network address. By way of example, the network address may be an Internet Provider (IP) address. Likewise, the telephone network 128 may switch information to a computer 40 in accordance with a telephone number.

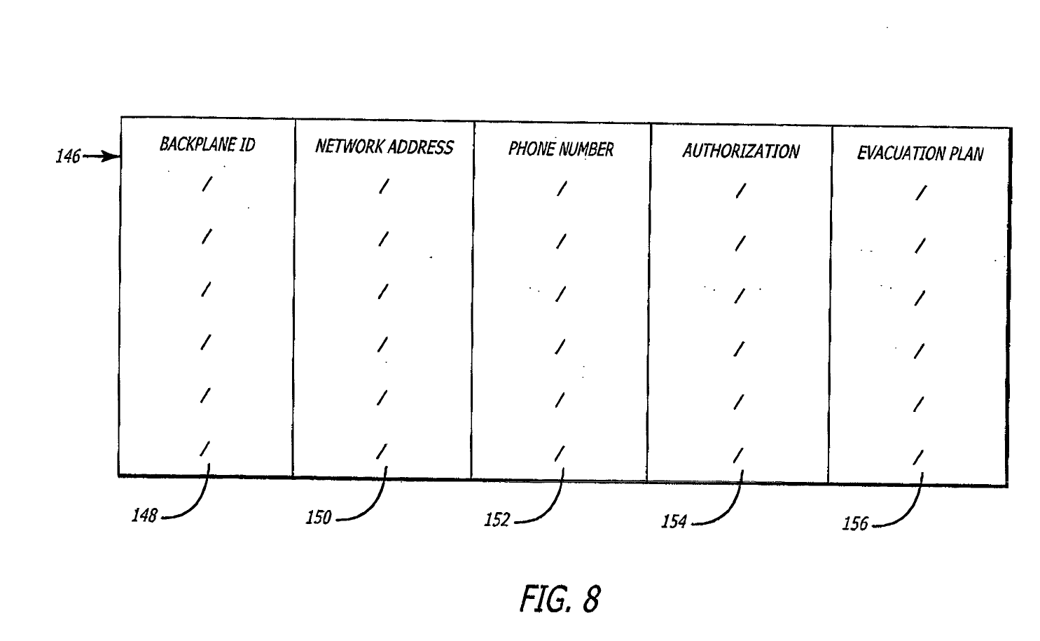

As shown in FIG. 8, the server 140 may include a relational database 146. The database 146 may have a backplane identification field 148, a network address field 150, a phone number field 152, an authorization field 154 and an evacuation plan field 156. The database 146 correlates each backplane identification and corresponding physical cable numbers of both the network connection and phone connection of the corresponding backplane, with a network address, phone number and evacuation plan.

The server 140 may operate in accordance with a software routine that accepts a command from the computer 40 and re-configures the networks 126 and 128 in accordance with the command. For example, the command may include the client identification and an instruction to re-configure the networks 126 and 128. The server 140 will then correlate the backplane identification and evacuation plan with the network address and phone number associated with the client identification. The server may include a look-up table that associates the client identification with a network address and phone number. The server 140 can then vary the network relational database to correlate the address and phone number of the client ID with the backplane that is mated with the computer. Once the networks 126 and 128 are re-configured all information associated with the address and phone number of the computer 40 plugged into the backplane 42 will be routed to the appropriate backplane 42.

The server 140 may also operate in accordance with a software routine that compares the client identification with an authorized client identification and activate the alarm 142 if the identifications do not match. The server 142 may also send a command to the backplane 42 to drive the lock 64 into a locked position so that the end user cannot unplug the computer 40 from the backplane 42. The server 140 may also inhibit operation of the computer 40. For example, the server may send a command(s) to turn off the computer 40 or prevent communication through the backplane 42.

The transmitter 62 may transmit the RF id if the computer 10 is improperly detached from the backplane 12. The RF id signal is received by the receiver 90. The server 82 may have a software routine that drives the alarm 88 and records the alarm event when the receiver 90 senses the RF id.

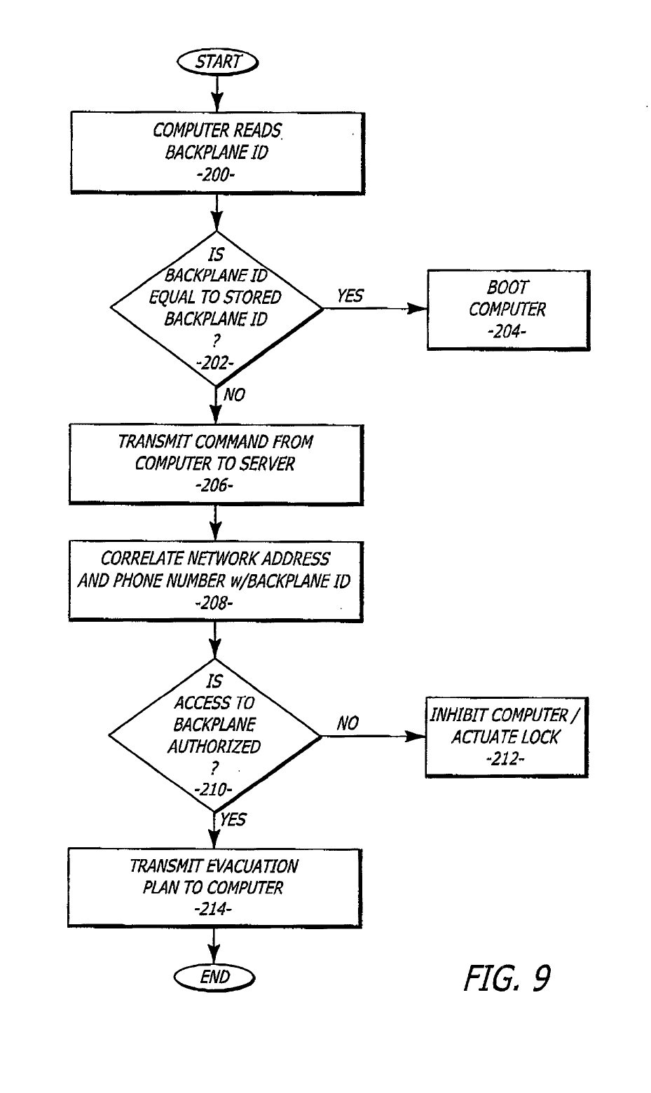

The microprocessor 102 of each computer 40 may operate in accordance with a software routine. The software routine may be performed in accordance with instructions and data stored within memory 106 and/or the hard disk drive 58. FIG. 9 describes an operation of the system by software routines performed by the computer 40 and the server 140.

The end user initially plugs the computer 40 into the backplane 42. The computer 40 then reads the backplane identification from the memory device 138 in process block 200. The backplane ID can be read during an initialization routine of the computer 40, wherein the processor 102 requests data from the appropriate address(es) of the backplane memory 138. In decision block 202 the computer 40 compares the backplane identification from the backplane 42 with the backplane identification stored in the computer 40. The stored backplane identification is the backplane ID for the backplane 42 that was last coupled to the computer 40. If the identifications match, a boot up routine is run so that the computer 40 can be operated in process block 204. Matching Ids signifies that the computer 40 has not been moved to a different backplane 42.

If the identifications do not match, the computer transmits a command to the server in block 206. The command may be routed to the server 140 in accordance with a server network address entered into the computer 40 through a configuration program. Alternatively, the server 140 may download the network address when the computer 40 is plugged into the backplane. The backplane 42 may send a signal to prompt the download of the server network address when the connectors mate. The command may include the client identification. The client ID may be retrieved from the hidden sector(s) of the hard disk drive 58. The server 140 then correlates the client identification information such as network address and phone number with the backplane identification in block 208. All information addressed to the network address and/or phone number will then be routed to the corresponding backplane associated with the client identification.

The server 140 may compare the client identification with an authorized client identification in decision block 210. If authorization is not granted the server 140 may transmit a command(s) to the backplane to inhibit operation of the computer and/or engage the lock in process block 212. If authorization is granted the server 140 may then transmit the evacuation plan 214 to the computer 40. The evacuation plan may include diagrams, etc. that show the end user an evacuation route from the facility. The evacuation plan is unique to the backplane, such that the evacuation route is specifically directed to the physical location of the backplane. The computer 40 can be booted subsequent to the transmission of the command in step 206.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A workstation, comprising:
a top;
a leg that supports said top; and,
a computer located within said leg.

2. The workstation of claim 1, further comprising a backplane located within said leg and connected to said computer.

3. The workstation of claim 2, further comprising a router that is attached to said backplane and located within said leg.

4. The workstation of claim 1, further comprising a monitor attached to said top and connected to said computer.

5. The workstation of said claim 4, further comprising a bracket that attaches said monitor to said top.

6. The workstation of claim 2, wherein said backplane contains a backplane identification and said computer compares the backplane identification with a stored backplane identification stored in said computer, said computer transmits a command through said backplane if the backplane identification does not match the stored backplane identification.

7. The system of claim 6, wherein said computer has a network address and the command re-configures a network to route information associated with the network address to said computer.

8. The system of claim 6, wherein said computer has a telephone number and the command re-configures a network to route information associated with the telephone number to said computer.

9. The system of claim 2, further comprising a keyboard that is coupled to said backplane.

10. The system of claim 2, wherein said backplane includes an input/output interface that is coupled to a plurality of input/output ports, said input/output ports each provide a communication path for information transmitted in an accordance with a different protocol.

11. The system of claim 2, further comprising a server that is attached to said backplane and located within said leg.

12. The system of claim 6, wherein the command includes a client identification.

13. A workstation, comprising:
a top;
a first leg that supports said top;
a second leg that supports said top;
a first computer located within said first leg;
a second computer located within said second leg; and,
a router that is located within said first leg and is coupled to said first and second computers.

14. The workstation of claim 13, further comprising a first backplane located within said first leg and connected to said first computer and a second backplane located within said second leg and connected to said second computer.

15. The workstation of claim 14, further comprising a server that is located within said first leg and coupled to said first and second computers.

16. The workstation of claim 13, further comprising a first monitor that is attached to said top and coupled to said first computer and a second monitor that is attached to said top and coupled to said second computer.

17. The workstation of said claim 16, further comprising a bracket that attaches said first and second monitors to said top.

18. A workstation of claim 14, wherein said first backplane contains a backplane identification and said first computer compares the backplane identification with a stored backplane identification stored in said first computer, said first computer transmits a command through said first backplane if the backplane identification does not match the stored backplane identification.

19. The system of claim 18, wherein said first and second computers each have a network address and the command re-configures a network to route information associated with the network addresses to said first and second computers.

20. The system of claim 18, wherein said first and second computers each have a telephone number and the command re-configures a network to route information associated with the telephone numbers to said first and second computers.

21. The system of claim 14, further comprising a keyboard that is coupled to said first backplane.

22. The system of claim 14, wherein said first and second backplanes each include an input/output interface that is coupled to a plurality of input/output ports, said input/output ports each provide a communication path for information transmitted in an accordance with a different protocol.

23. The system of claim 13, further comprising a single cable that is coupled to said first leg.

24. The system of claim 18, wherein the command includes a client identification.

25. A workstation, comprising:
a top;
a first leg that supports said top;
a second leg that supports said top;
a first computer located within said first leg;
a second computer located within said second leg; and,
a switch that is located within said first leg and is coupled to said first and second computers.

26. The workstation of claim 25, further comprising a first backplane located within said first leg and connected to said first computer and a second backplane located within said second leg and connected to said second computer.

27. The workstation of claim 25, further comprising a router that is located within said first leg and coupled to said first and second computers.

28. The workstation of claim 25, further comprising a server that is located within said first leg and coupled to said first and second computers.

29. The workstation of claim 25, further comprising a first monitor that is attached to said top and coupled to said first computer and a second monitor that is attached to said top and coupled to said second computer.

30. The workstation of said claim 29, further comprising a bracket that attaches said first and second monitors to said top.

31. A workstation of claim 26, wherein said first backplane contains a backplane identification and said first computer compares the backplane identification with a stored backplane identification stored in said first computer, said first computer transmits a command through said first backplane if the backplane identification does not match the stored backplane identification.

32. The system of claim 31, wherein said first and second computers each have a network address and the command re-configures a network to route information associated with the network addresses to said first and second computers.

33. The system of claim 31, wherein said first and second computers each have a telephone number and the command re-configures a network to route information associated with the telephone numbers to said first and second computers.

34. The system of claim 24, further comprising a keyboard that is coupled to said first backplane.

35. The system of claim 24, wherein said first and second backplanes each include an input/output interface that is coupled to a plurality of input/output ports, said input/output ports each provide a communication path for information transmitted in an accordance with a different protocol.

36. The system of claim 31, wherein the command includes a client identification.

37. A method for assembling a workstation, comprising:
plugging a computer into a leg that supports a top.

38. The method of claim 37, further comprising transmitting a backplane identification to the computer from a backplane located within the leg, comparing the backplane identification with a stored backplane identification, transmitting a command to a network if the backplane identification does not match the stored backplane identification.

39. The method of claim 38, further comprising re-configuring a relational database so that the backplane identification is correlated with a network address of the computer.

40. The method of claim 38, further comprising re-configuring a relational database so that the backplane identification is correlated with a telephone number of the computer.

41. The method of claim 38, further comprising comparing a client identification transmitted with the command with an authorized client identification and inhibiting operation of the computer if the client identification does not match the authorized client identification.

42. The method of claim 41, further comprising activating an alarm if the client identification does not match the authorized client identification.
